(19) United States
(12) Patent Application Publication
(10) Pub. No.: US 2026/0194102 A1
(43) Pub. Date: Jul. 9, 2026

(54) Insert

(71) Applicant: Japan Life Co., Ltd.,, Tokyo (JP)

(72) Inventors: Hiroshi IWASHITA, Tokyo (JP); Takashi YAMAMOTO, Tokyo (JP)

(21) Appl. No.: 19/379,831

(22) Filed: Nov. 5, 2025

(30) Foreign Application Priority Data
Jan. 8, 2025 (JP) 2025-002909

(51) Int. Cl. F16B 41/00

(52) U.S. Cl. CPC F16B 41/005

(57) ABSTRACT

In order to prevent the loosening of a screw member of an insert, an opening portion of an accommodation hole is provided in the distal end portion of an insert body embedded in a concrete structure, and a female screw is formed in the base end portion of the insert body. A male screw of a bolt screws into the female screw, and installation equipment is fastened to the concrete structure by the bolt. A cap covering the accommodation hole is formed in the base end portion of the insert body, and the cap has a cylindrical portion into which a female screw groove is dug into by the distal end portion of the bolt.

### CROSS-REFERENCE TO RELATED APPLICATIONS

This application claims priority from Japanese Patent Application No.2025-002909 filed on January 8, 2025. The entire contents of which are hereby incorporated by reference into this application.

### TECHNICAL FIELD

The present invention relates to an insert embedded in a concrete structure in order to secure installation equipment such as a processing machine to a concrete construction such as a concrete slab.

### Technological Background

An insert, which is a type of concrete anchor, is used to secure a processing machine such as a pressing machine, a laser cutter, or a lathe to a concrete slab, which is a base plate made of concrete. An insert is also used to secure a suspended item such as a drainpipe, a gutter, or scaffolding to a bridge made of concrete. Further, an insert is also used to secure an auxiliary device such as a jet fan for exhaustion or an exhaust duct to the inner surface of a tunnel made of concrete.

The insert for securing installation equipment such as a processing machine, a suspended item, or an auxiliary device to a concrete structure as described above is embedded in a concrete construction as a type of anchor member.

Patent document 1 discloses an insert for securing pipework, which is installation equipment, to a wall of a structure such as a concrete building. The insert has an insert body which is embedded in the wall of the structure, and by fastening a mounting tool which is secured to the pipework to the insert body with a fastening screw member, the pipework is secured to the wall, and the fastening screw member is embedded in the structure along with the insert body.

### Related documents

Patent Document 1: JP 2005-180016 A

### SUMMARY OF THE INVENTION

### Problem to be Solved by the Invention

When installation equipment such as a suspended item vibrates, that vibration is carried to the mounting tool secured to the installation equipment. Accordingly, it is assumed that when a long time passes after securing the installation equipment to the concrete structure, the screw member of the insert loosens due to the vibration of the mounting tool. For this reason, the amount of time between maintenance checks of the installation equipment which is secured to the concrete structure cannot be extended. Even if the installation equipment vibrates, if the loosening of the screw member can be prevented, then the reliability of the insert can improve and the amount of time between maintenance checks of the installation equipment can be extended.

The present invention has been made in view of the above technical background and aims to provide technology capable of preventing the loosening of screw portions of an insert.

### Means for Solving the Problem

In order to solve the problem above, an embodiment of the insert of the present invention as has an insert body which is embedded in a concrete structure, and in which an opening of an accommodation hole is provided at a distal end portion thereof, a bolt which fastens installation equipment to the concrete structure and which is provided with a male screw which screws into a female screw provided in a base end portion of the insert body, and a cap which covers the accommodation hole and which is fitted to the base end portion of the insert body, and the cap has a cylindrical portion in which the distal end portion of the bolt digs into a female screw groove.

An embodiment of the present invention features the cap being formed of materials that have less strength than the bolt in the invention.

An embodiment of the present invention features having a metal washer arranged between a mounting tool secured to the installation equipment and the head portion of the bolt, and the fastening ability of the bolt is passed on to the mounting tool via the metal washer in the invention.

### Effect of Invention

According to an embodiment of the present invention, the installation equipment is fastened to the concrete structure by the bolt screwed into the female screw of the insert body embedded in the concrete structure, in the cap provided at the base end portion of the insert body, a cylindrical portion is provided in which the distal end portion of the bolt digs into the female screw groove, and the bolt is prevented from being loosened due to vibrations by the cap which covers the base end portion of the insert body.

According to an embodiment of the present invention, the bolt can be easily assembled into the insert body by being rotated relative to the insert body.

According to an embodiment of the present invention, the fastening ability of the bolt can be passed on to the mounting tool via the metal washer and the loosening of the bolt may be prevented.

### BRIEF DESCRIPTION OF THE DRAWINGS

FIGS. 1A, 1B, and 1C are cross-sectional views showing an insert relating to an embodiment of the present invention, FIG. 1A is a cross-sectional view showing an insert embedded in a concrete slab in order to secure a processing machine such as a pressing machine to the concrete slab, FIG. 1B is a cross-sectional view showing an insert embedded in a bridge made of concrete in order to secure a suspended item such as a drainpipe to the bridge, and FIG. 1C is a cross-sectional view showing an insert secured to a concrete tunnel in order to secure an auxiliary device such as an exhaust duct to an inner surface of the tunnel.

FIG. 2 is a perspective view showing a mounting tool secured to a processing machine and an insert as shown in FIG. 1A.

FIG. 3 is a perspective view showing a mounting tool secured to a suspended item and an insert as shown in FIG. 1B.

FIG. 4 is a perspective view showing a mounting tool secured to an auxiliary device and an insert as shown in FIG. 1C.

FIG. 5 is a disassembled cross-sectional view of an insert relating to an embodiment of the present invention.

FIG. 6 is a cross-sectional view of an insert in a state in which installation equipment is secured to a concrete structure.

### EMBODIMENTS FOR REALIZING THE INVENTION

Hereinafter, exemplary embodiments of the present invention will be described in detail based on the drawings. In the drawings for describing the embodiments, the same components are denoted by the same reference numerals in principle, and repeated descriptions thereof will be omitted.

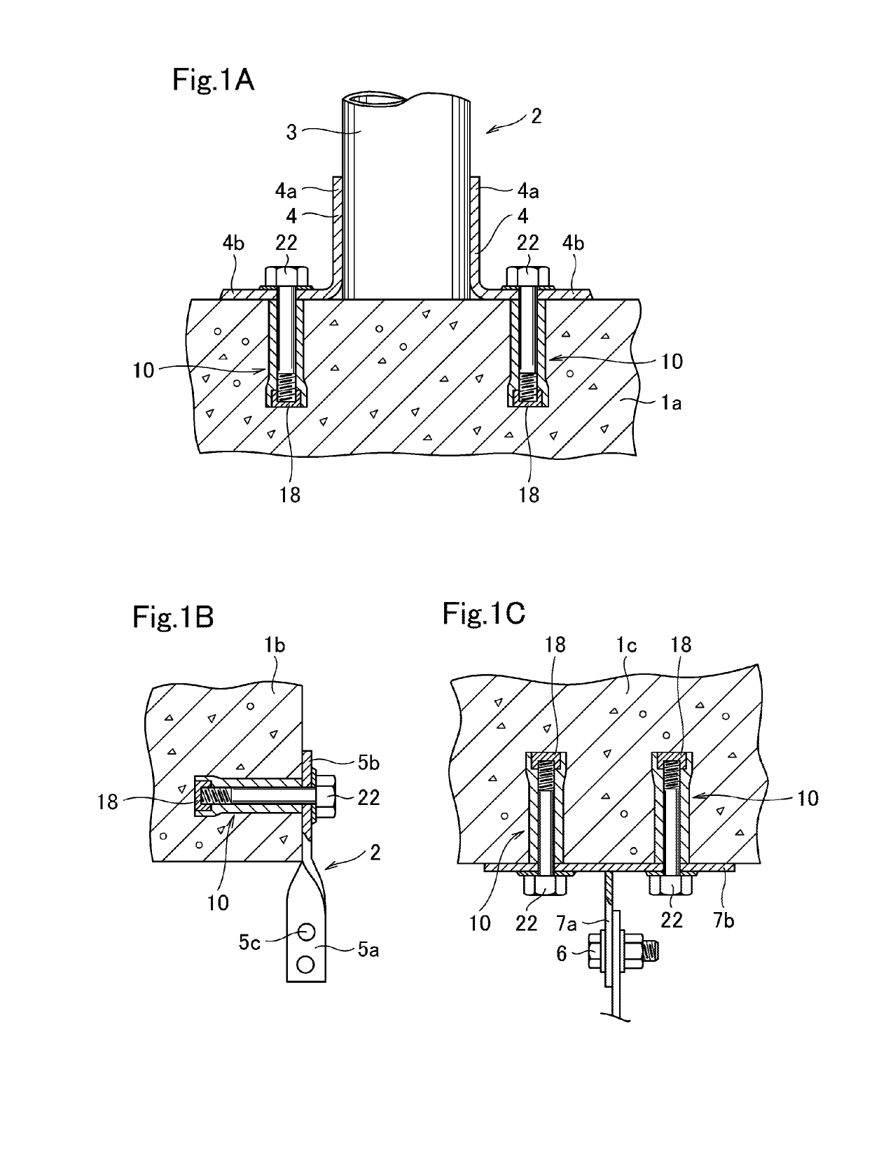

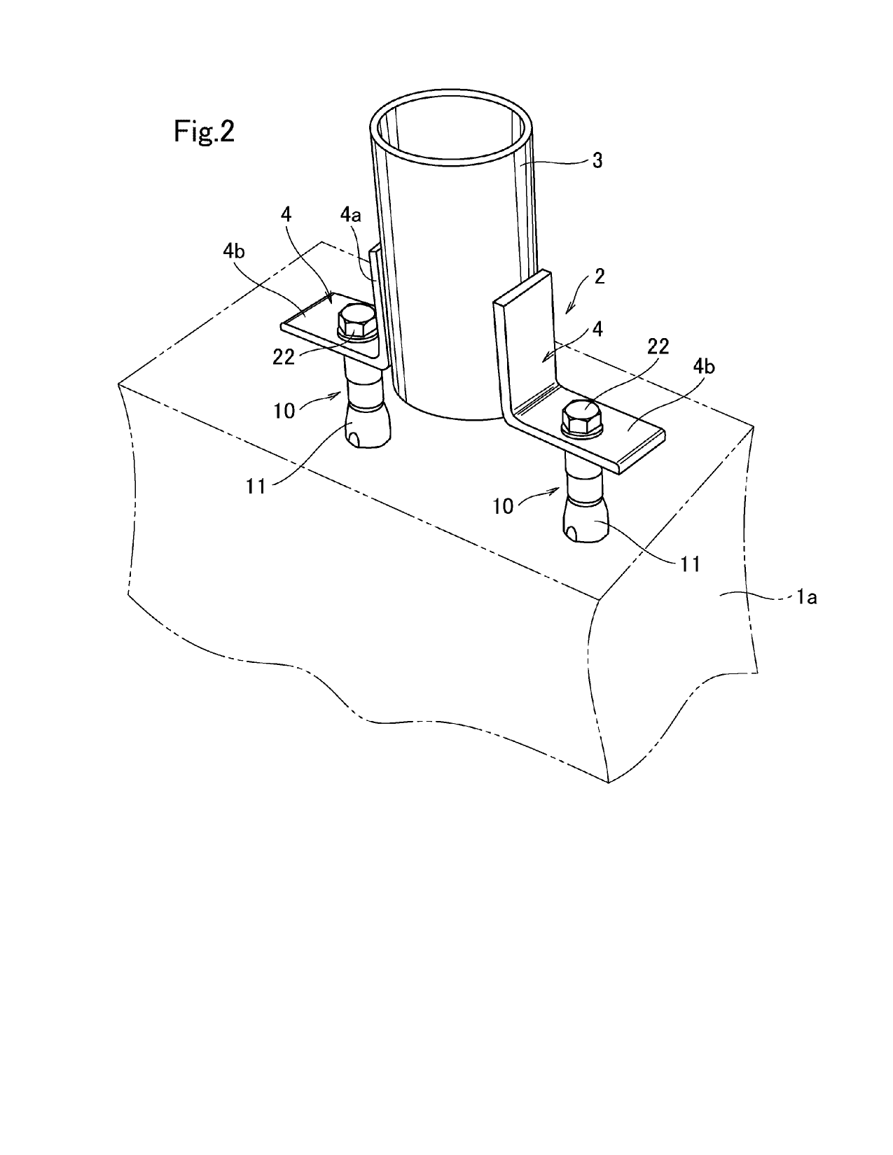

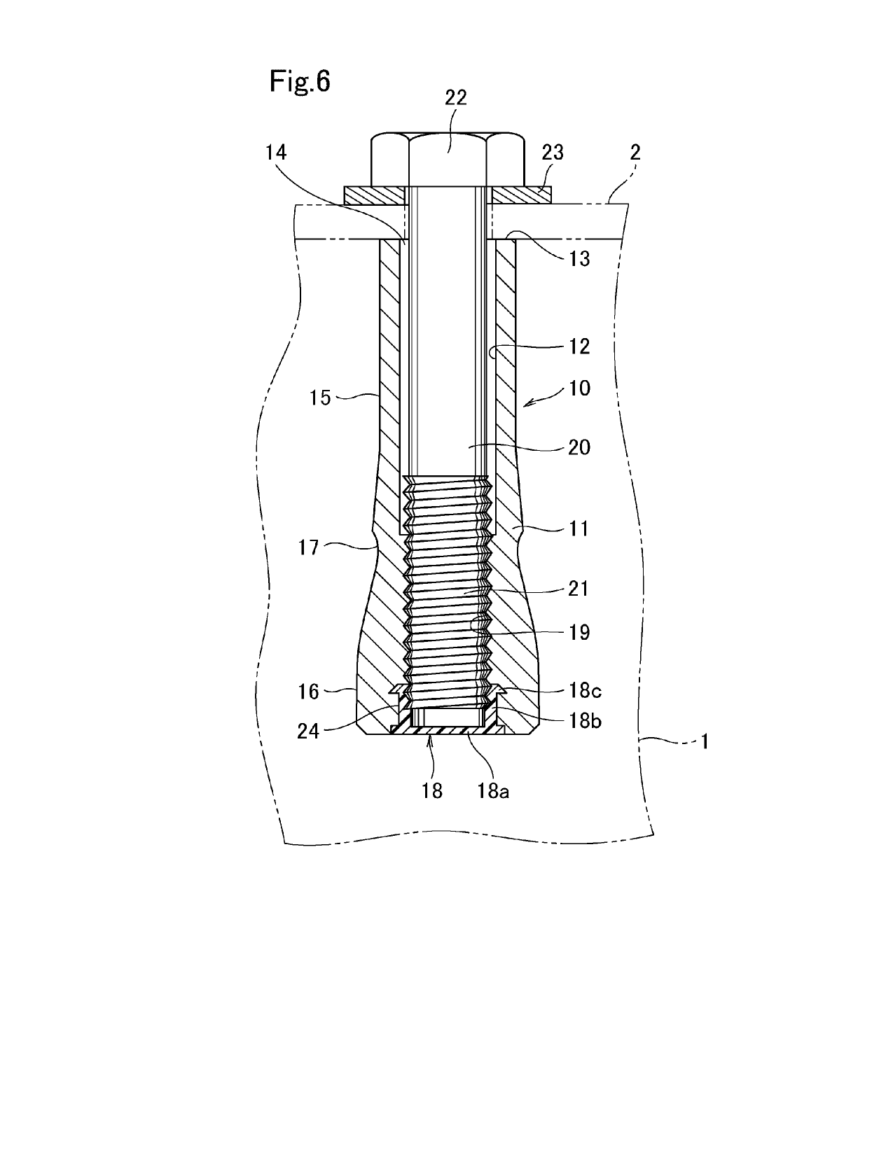

As shown in FIG. 1A and FIG. 2, a mounting tool 2 for securing a processing machine which is a type of installation equipment to the upper surface of a concrete slab 1a which is a concrete structure 1 (FIG. 6) has a cylindrical member 3 to which the processing machine is secured, and two legs 4 fixed to the cylindrical member 3. Each of the legs 4 have a fixed portion 4a which is welded and fixed to the cylindrical member 3, and a fastening portion 4b which is bent at a right angle with respect to the fixed portion 4a. The fastening portion 4b is fastened to the concrete slab 1a by two inserts 10 embedded in the concrete slab 1a.

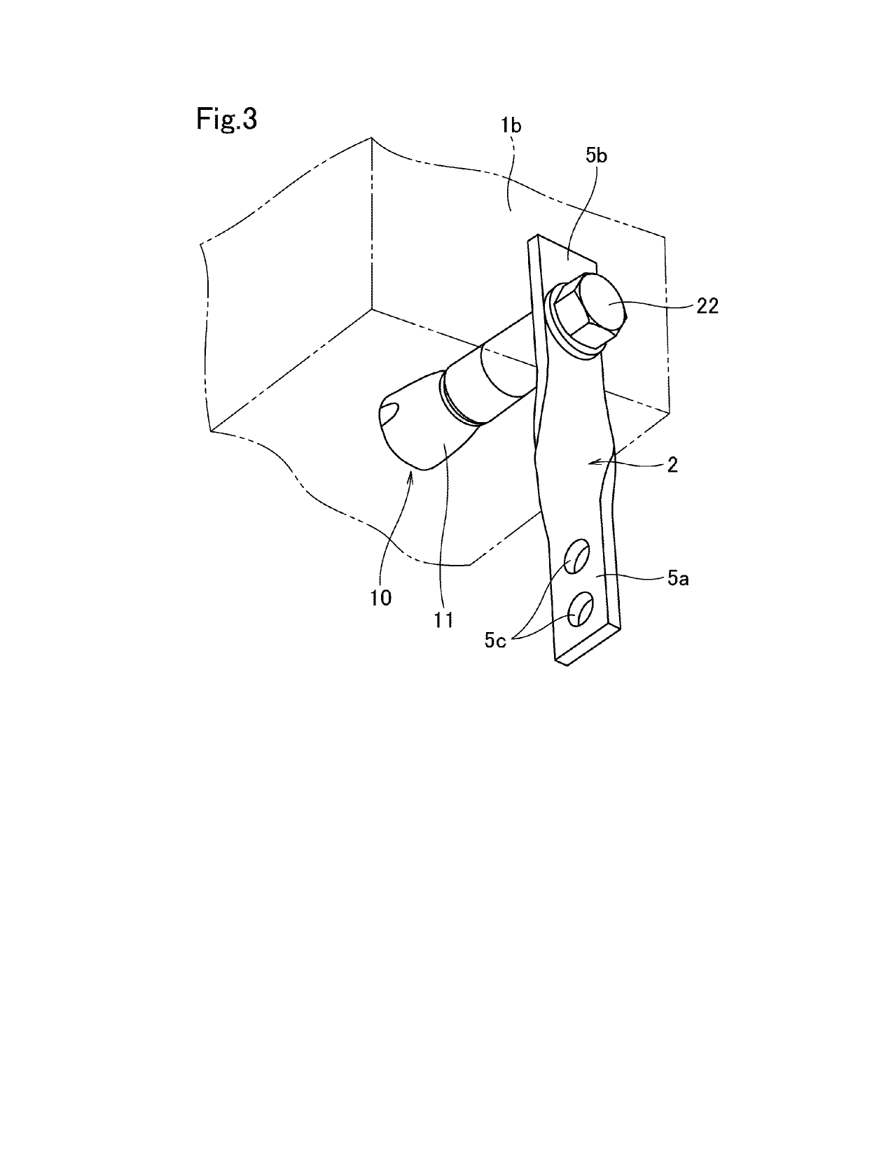

As shown in FIG. 1B and FIG. 3, the mounting tool 2 for securing a suspended item which is a type of installation equipment on the side surface of a concrete bridge 1b has a fixed portion 5a to which the suspended item is mounted, and a fastening portion 5b which is twisted at a right angle with respect to the fixed portion 5a. In the fixed portion 5a, a screw hole 5c for securing a suspended item is formed, and the fastening portion 5b is fastened to the bridge 1b by the insert 10 buried in, or in other words, embedded in the bridge.

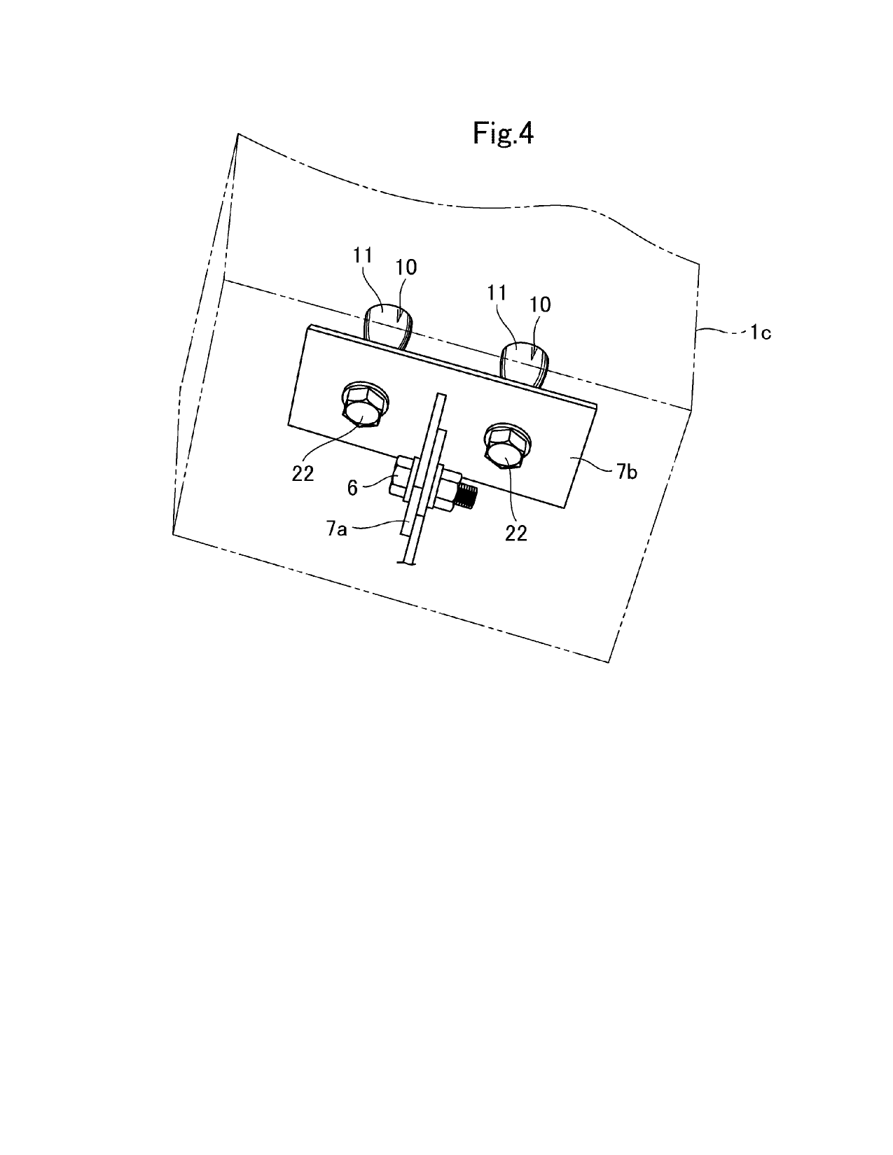

As shown in FIG. 1C and FIG. 4, the mounting tool 2 for securing an auxiliary device which is a type of installation equipment to the inner surface of a tunnel 1c has a fixed portion 7a to which the auxiliary device is mounted by a bolt 6, and a fastening portion 7b onto which the fixed portion 7a is welded to the outer surface thereof. The fastening portion 7b is fastened to the tunnel 1c by two inserts 10 embedded in the tunnel 1c.

In FIG. 1A and FIG. 1C, two inserts 10 are shown embedded in a concrete structure, and in FIG. 1B, one insert 10 is shown embedded in a concrete structure.

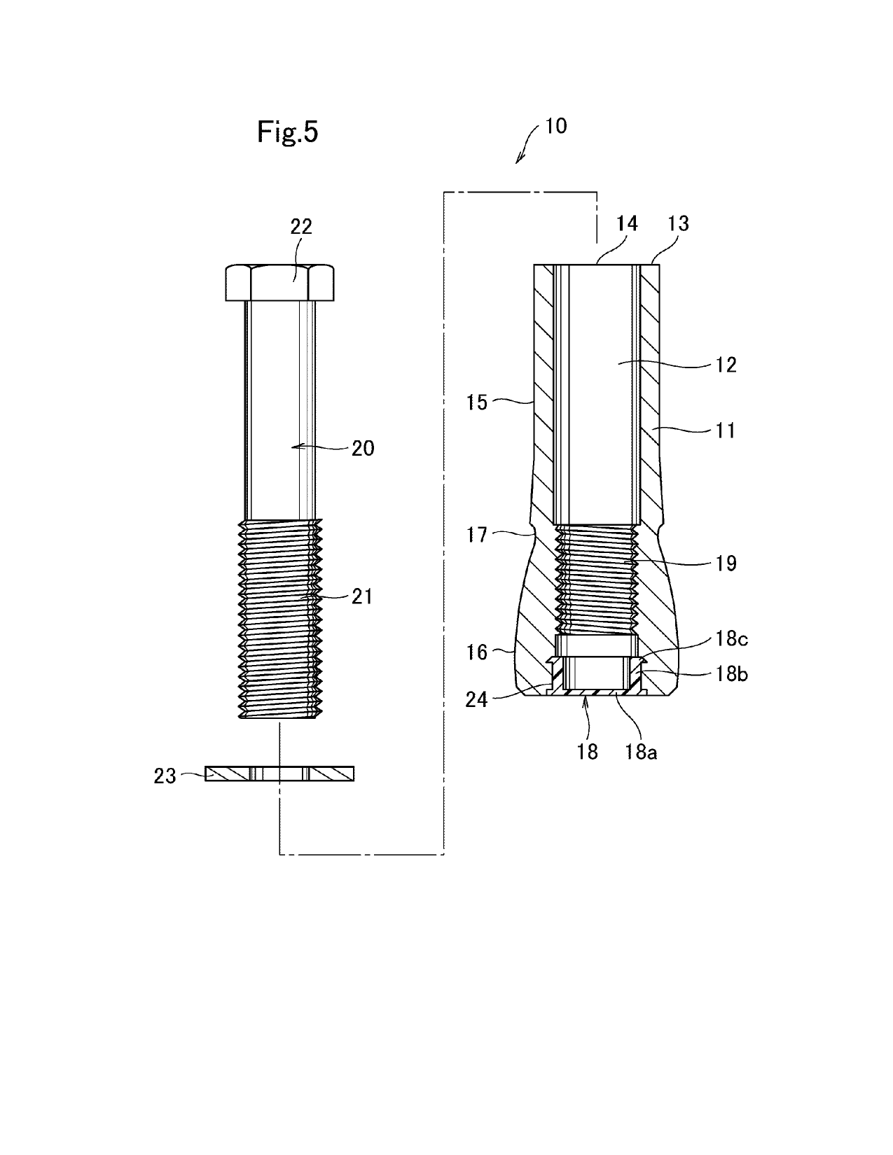

FIG. 5 is a disassembled cross-sectional view of an insert 10 relating to an embodiment of the present invention shown in FIG. 1-4. FIG. 6 is a cross-sectional view of an insert in a state in which installation equipment is secured to a concrete structure 1.

An insert 10 has an insert body 11 embedded in a concrete structure 1, and the insert body 11 is formed of ceramics such as alumina. In the insert body 11, an accommodation hole 12 is formed, and the accommodation hole 12 opens on the outer portion thereof with an opening portion 14 provided at a distal end surface 13 of the insert body 11.

The outer diameter of the distal end side portion of the insert body 11 is a nearly constant straight portion 15, and a bulging portion 16 having a larger diameter than the straight portion 15 is formed in the base end side portion, and a constricted portion 17 is formed between the bulging portion 16 and the straight portion 15. The insert body 11 digs into and is firmly embedded in the concrete structure 1 by the bulging portion 16 and the constricted portion 17.

When constructing the concrete structure 1, the insert body 11 is preliminarily secured to a formwork and embedded in the concrete structure 1 by casting concrete into the formwork. In a state in which the insert body 11 is embedded, the distal end surface 13 is exposed on the outer surface of the concrete structure 1.

As shown in FIG. 1A and FIG. 2, when the insert 10 is used to secure a processing machine to the concrete slab 1a, the insert body 11 is embedded in the concrete slab 1a. As shown in FIG. 1B and FIG. 3, when the insert 10 is used to secure a suspended item to a bridge, the insert body 11 is embedded in the bridge 1b. Further, as shown in FIG. 1C and FIG. 4, when the insert 10 is used to secure an auxiliary device to a tunnel, the insert body 11 is embedded in the tunnel.

In the base end portion of the insert body 11, a cap 18 for blocking the accommodation hole 12 is secured, and when embedding the insert body 11 into a concrete structure 1 such as a concrete slab 1a, the concrete casted into the formwork is prevented from overflowing into the accommodation hole 12 by the cap 18.

The cap 18 is formed of synthetic resin such as nylon which is a material that has less strength than the material of the insert body 11 and has an endplate portion 18a which blocks the accommodation hole 12, and a cylindrical portion 18b which fits with the inner circumferential surface of the accommodation hole 12. An engagement portion 18c is provided at the distal end of the cylindrical portion 18b and protrudes radially outward from the cylindrical portion 18b. Thus, the engagement portion 18c engages with a groove formed in the insert body 11, thereby preventing the cap 18 from detaching from the insert body 11.

In the base end portion of the insert body 11, a female screw 19 is provided at a position further on the distal end portion side of the insert body 11 than the cap 18.

The insert 10 has a bolt 20 which assembles into the inside of the accommodation hole 12 of the insert body 11. In the distal end portion of the bolt 20, a male screw 21 is provided so as to screw into, in other words join with, the female screw 19, and a head portion 22 is provided on the end portion.

The male screw 21 is a right screw, and when the bolt 20 is rotated in a right direction from the axial direction, the bolt 20 moves in a direction which penetrates the female screw 19, and when rotated in the opposite direction, moves in a direction away from the female screw 19. The male screw 21 is a single thread screw in which the shape of the screw threads is triangular.

The insert 10 is composed of an insert body 11 and a bolt 20. The bolt 20 is assembled into the insert body 11 which is preliminarily embedded in the concrete structure 1, and is embedded into the concrete structure 1 along with the insert body 11.

When installation equipment is secured to the concrete structure 1, in a state in which the metal washer 23 is fitted, the bolt 20 is secured to the insert body 11 by joining the male screw 21 with the female screw 19 of the insert body 11. At this time, the cap 18 is formed of a material having less strength than the bolt 20, so as shown in FIG. 6, the distal end portion of the male screw 21 of the bolt 20 digs into the cylindrical portion 18b, and the female screw groove 24 is formed in the cylindrical portion 18b of the cap 18. As a result, by securing the bolt 20 to the insert body 11, the bolt 20 and the insert body 11 are firmly joined, and the cap 18 for preventing the overflow of concrete into the accommodation hole 12 also functions to prevent the loosening of the screws.

In FIG. 6, a concrete structure such as a concrete slab 1a is shown by reference numeral 1, and a state in which a mounting tool 2 which is secured to the installation equipment is fastened by a bolt 20 which is a screw member is shown.

When securing the installation equipment to the concrete structure 1 using the insert 10, as shown in FIG. 6, in a state in which the mounting tool 2 secured to the installation equipment abuts the outer surface of the concrete structure 1 and also abuts the distal end surface 13 of the insert body 11, the bolt 20 is assembled to the insert body 11. The metal washer 23 is fitted between the head portion 22 of the bolt 20 and the mounting tool 2, and the fastening ability of the bolt 20 is passed on to the mounting tool 2 via the metal washer 23.

The outer surface of the metal washer 23 is abutted by the head portion 22 of the bolt 20, and the inner surface of the metal washer 23 is abutted by the distal end surface 13 of the insert body 11, so the fastening ability of the head portion 22 of the bolt 20 is passed on to the distal end surface 13 via the metal washer 23 and the mounting tool 2. Thus, the mounting tool 2 of the installation equipment is firmly secured to the insert 10.

The male screw 21 of the bolt 20 digs into the cylindrical portion 18b of the cap 18 and is fastened to the cap 18 so as to form the female screw groove 24 through the elastic deformation of the cylindrical portion 18b. Thus, the prevention by the cap 18 of the loosening of screws is improved, and even if the mounting tool 2 and the like of the installation equipment vibrates, the loosening of the bolt 20 is reliably prevented.

However, the male screw 21 of the bolt 20 which screws into the female screw 19 of the insert body 11 may be a self-tapping screw so as to deeply cut the female screw groove 24 into the cylindrical portion 18b of the cap 18. In addition, a self-tapping screw with a smaller diameter than the male screw 21 may protrude from the end surface of the male screw 21. In this case, the inner surface of the cylindrical portion 18b of the cap 18 may be set with a smaller diameter than the case illustrated.

The present invention as made by the inventors has been explicitly described based on the embodiments. However, all aspects of the embodiments disclosed in this specification are examples, and the invention is not limited to the technology disclosed. That is to say, the technological scope of the present invention should not be interpreted in a limited manner based on the description of the embodiments above and should be interpreted in accordance with the description of the scope of the claims. The present invention includes technology equivalent to the technology described in the claims and all variations thereof, so long as they do not deviate from the gist of the scope of the claims.

For example, the installation equipment secured to the concrete structure 1 is not limited to processing machines and the like described above, and may be something capable of being secured to the insert 10 by a screw member. In addition, the male screw 21 and the female screw 19 are not limited to triangular screws having triangular cross-sectional screw threads, and may be trapezoidal screws having trapezoidal cross-sectional screw threads, square screws having cross-sectional screw threads running close to a forward direction, or sawtooth screws which are a combination of square screws and triangular screws, or still further, may be round screws with rounded cross-sectional screw threads.

In addition, in the present embodiments, the insert body 11 is formed of ceramics, but may also be formed of materials other than ceramics, for example, metals such as stainless steel, iron, or aluminum.

### Industrial Use

The insert of the present invention has an insert body embedded in a concrete structure such as a concrete slab or a bridge made of concrete, and can be used for securing installation equipment to the concrete structure by a screw member screwed into the insert body.

### Explanation of reference numerals

1: Concrete structure

1a: Concrete slab

1b: Bridge

1c: Tunnel

2: Mounting tool

3: Cylindrical member

4: Leg

4a: Fixed portion

4b: Fastening portion

5a: Fixed portion

5b: Fastening portion

6: Bolt

7a: Fixed portion

7b: Fastening portion

10: Insert

11: Insert body

12: Accommodation hole

13: Distal end surface

14: Opening

15: Straight portion

16: Bulging portion

17: Constricted portion

18: Cap

18a: Endplate portion

18b: Cylindrical portion

18c: Engagement portion

19: Female screw

20: Bolt

21: Male screw

22: Head portion

23: Metal washer

24: Female screw groove

1. An insert comprising:
an insert body embedded in a concrete structure, in which an opening of an accommodation hole is provided at a distal end portion thereof;
a bolt that fastens installation equipment to the concrete structure, in which a male screw is provided that screws into a female screw provided in the base end portion of the insert body; and
a cap that is fitted to the base end portion of the insert body and covers the accommodation hole, wherein
the cap has a cylindrical portion in which the distal end portion of the bolt digs into a female screw groove.

2. The insert according to claim 1, wherein the cap is formed of a material having less strength than the bolt.

3. The insert according to claim 1, further comprising a metal washer arranged between a mounting tool secured to the installation equipment and the head portion of the bolt, wherein
the fastening ability of the bolt is passed on to the mounting tool via the metal washer.
